(19) United States
(12) Patent Application Publication
(10) Pub. No.: US 2009/0089350 A1
(43) Pub. Date: Apr. 2, 2009

(54) MODULAR REDUCTION OPERATOR

(75) Inventors: Alain SAUZET, Bondoufle (FR); Florent Bernard, Monistrol Sur Loire (FR); Eric Garrido, Soisy/Montmorency (FR)

Correspondence Address: LOWE HAUPTMAN & BERNER, LLP, 1700 DIAGONAL ROAD, SUITE 300, ALEXANDRIA, VA, 22314, US

(73) Assignee: THALES, NEUILLY SUR SEINE (FR)

(21) Appl. No.: 12/134,751

(22) Filed: Jun. 6, 2008

(30) Foreign Application Priority Data
Jun. 7, 2007 (FR) 07 04087

(51) Int. Cl. G06F 7/38

(52) U.S. Cl. 708/491

(57) ABSTRACT

This invention concerns an improved modular reduction device. The modular reduction device includes a multiplier using an alternative of the Montgomery multiplication process using a high numeration base r with r being equal to or greater than 4. It applies more particularly to the calculation components used for asymmetrical cryptography.

### RELATED APPLICATIONS

The present application is based on, and claims priority from, French Application Number 07 04087, filed Jun. 7, 2007, the disclosure of which is hereby incorporated by reference herein in its entirety.

### FIELD OF THE INVENTION

This invention concerns an improved modular reduction device. It applies particularly to the calculation components used for asymmetrical cryptography.

### BACKGROUND OF THE INVENTION

Generally, public key ciphering processes apply to calculations taking place in a modular ring of algebraic numbers. The cryptographic operations are therefore performed with modular arithmetic and a modular reduction operation is often required. Indeed, in a ring Zₙ, this operation allows conversion of a primary number greater than n into a number smaller than n and congruous with the former. A major stake related to the performance of the cryptographic calculation components concerns this operation.

One natural method of obtaining a modular reduction is to calculate and Euclidean division, the result being equal to the remainder of this division. However, the performance of an operation like this is particularly mediocre and the division calculation generally requires the use of a microprocessor. At present, some modular reduction processes allow a result to be obtained with very short calculation times but are generally limited by the size of the numbers to be processed. Other processes are flexible. That means that to the contrary they are capable of processing any size of a number but often require a very long calculation time. A patent published under number EP0712071 also proposes a modular reduction process according to the Montgomery method. However, this process requires the calculation of a parameter H, a calculation considered pointless for some applications. In addition, there is no solution in a prior embodiment that can be integrated easily into cryptographic components comprising other calculation modules.

### SUMMARY OF THE INVENTION

One purpose of the invention is to produce a device implementing a modular reduction process that is capable of processing in a reduced calculation time, numbers whose size is not determined if advance, wherein such a device can be integrated, for instance, easily into a cryptographic calculation component. For this purpose, the invention is designed to produce a modular reduction device, comprising a multiplier implementing a Montgomery multiplication operation using a high numeration base r that is equal to or greater than 4.

The multiplier can implement the following algorithm:

S←p₀.q

For i ranging from 0 to tₙ−1, apply:

mᵢ←S₀.n′ mod r

S←pᵢ.q+(mᵢn+S)/r

mₜₙ←S₀.n′ mod r

S←(mₜₙ.n+S)/r

where tₙ designates the size of the module n as a number of machine-words, p and q are the operands to be multiplied, mᵢ are intermediate coefficients, S is the result of the multiplication and the value n′ is equal to −n⁻¹ mod r.

According to one embodiment, the multiplier includes a multiplier-adder comprising p logic couples-pipelined register, receiving several digits to be added and multiplied, at a least two outputs containing the least significant and most significant bits, and to be multiplied, at least two outputs from a multiplier-adder, where number p is chosen in such a way that the maximum frequency F1max of the multiplier-and there is greater than or equal to the maximum adder frequency F2max.

The modular reduction device can also include a sequencer, an adder block and a memory module with one sequencer output connected to a control input of the adder block, another sequencer output connected to a control input of the multiplier, and the memory module connected to the multiplier and the adder in order to exchange data.

The purpose of the invention is also a cryptographic component including a modular reduction device as described above.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1, a block diagram of the modular reduction device according to the invention,

FIG. 2, an example of the multiplication-addition cell used by the modular reduction device according to the invention,

FIG. 3, an example of a Montgomery modular multiplier used by the modular reduction device according to the invention.

### DETAILED DESCRIPTION OF THE INVENTION

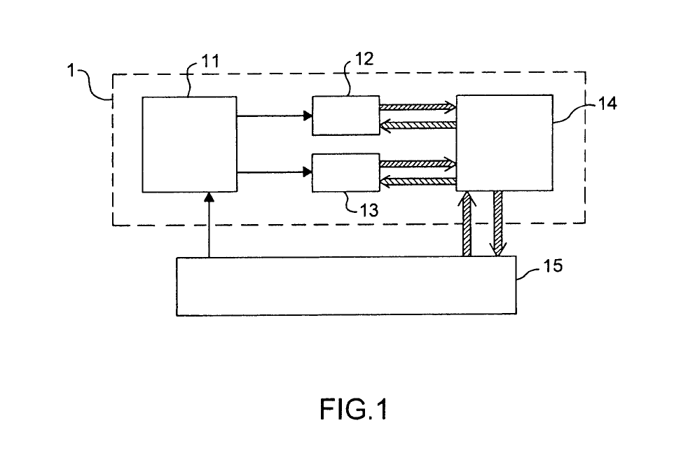

FIG. 1 present a block diagram of the modular reduction device according to the invention. Modular reduction device 1 includes a sequencer 11, a multiplier block 12, an adder block 13, and a memory module 14. The multiplier block 12 and the adder block 13 receive controls from the sequencer 11 and exchange each of the data with memory module 14. A user application 15 feeds the controls to sequencer 11 and exchanges data with memory module 14.

The manipulated data is recorded on machine-words each consisting of b bits. Size b of the machine-words is generally to the power of 2. Numeration base r is defined as being equal to 2^{b}. Modulus n is an odd number recorded on tₙ machine-words. R is defined as a power of the numeration base r, where R is greater than modulus n. A number x can be broken down in base r into t+1 digits xᵢ as follows:

x=x₀+x₁.r+x₂.r²+ . . . +xₜ.r^{t},

where each digit xᵢ is the size of a machine-word.

Finally, a set of numbers gᵢ is defined as follows: gᵢ=R²⁺ⁱ mod n, with i varying from 0 to k−1, k being a maximum value determined for instance by user application 15 of the invention. The values gᵢ are precalculated, for instance, by user application 15 of the invention by another modular reduction method. Indeed, the values gᵢ cannot be precalculated by modular reduction device 1 because these values gᵢ are necessary for the operation of the device. Once these values gᵢ have been calculated, modular reduction device 1 is capable of calculating x mod n for values of x at the most equal to R^{k+1}−1.

Modular reduction device 1 according to the invention uses the following process to reduce the number x:

Set s=0, u=0

For i varying from 0 to k−1, perform the following operations:

u←MMul(xᵢ, gᵢ)

s←MAdd(s, u)

return MMul(s, 1).

where u and s are temporary variables, MMul( ) is a modular multiplication algorithm implemented in multiplier block 12 and explained below and MAdd( ) is a modular addition algorithm used in adder block 13.

Memory module 14 memorises the numbers n, gᵢ, the digits xᵢ of x and the values u and s. Sequencer 11 controls multiplier block 12 and adder block 13 to carry out the modular reduction algorithm using the data recorded in memory module 14.

Multiplier block 12 uses an alternative of the Montgomery algorithm working on a high numeration base r (r>=4). It works with the value of R=r^{tn+1}. The digits x, used by sequencer 11, therefore have a size of tₙ+1 words.

Another value noted as n′ and equal to −n⁻¹ mod r, has to be precalculated, for instance by the user application 15 of the invention. Multiplier block 12 has, for instance, an initial register memorising the value tₙ and a second register memorising the value n′. These two registers are loaded when the block is initialised.

Multiplier block 12 interfaces with memory module 14 from which it takes its parameters and places the result of the calculation. At the input it takes two numbers having a size of tₙ+1 words and the result is a number of tₙ₊1 words. Since the size of module n is tₙ words, it can be expressed that inputs p and q in the form of p=p′+eₚ.n and q=q′+e_{q}.n, where p′ and q′ are less than n, and eₚ and e_{q} have a binary size ≦2b bits. Multiplier block 12 calculates a value c such that c=c′+e_{c}.n, where e_{c} has a binary size ≦2b bits, and c′ is congruous with a.b.R⁻¹ mod n. Subsequently, the digits of a number N in base r are noted as Nᵢ.

To be able to perform a Montgomery modular multiplication operation of two numbers p and q, multiplier block 12 implements the following process:

i. S←p₀.q

ii. For i ranging from 0 to tₙ−1, use:

a. mᵢ←S₀.n′ mod r

b. S←pᵢ.q+(mᵢn+S)/r

iii. mₜₙ←S₀.n′ mod r

iv. S←(mₜₙ.n+S)/r

where the values mᵢ are intermediate calculation coefficients and S is the result.

Operations ii.b and iv can be carried out by a “machine-word×number+number” multiplier-adder. Operation i is carried out by a “machine-word×number” of multiplier. Division by r operations are carried out by the hardware, offsetting the result of a machine-word towards the least significant bit digit.

Multiplier block 12 includes three parallel inputs of b bits : Pᵢ, Qᵢ and Nᵢ, which receive at each stage of the process the digits p, q and n respectively. The transmission of the input operands to multiplier block 12 is therefore carried out in serial/parallel mode. Multiplier block 12 also includes a parallel output of b bits, producing a machine-word at each stage. The output of the result is therefore carried out in serial/parallel mode.

Modular reduction device 1 is controlled by a microprocessor or another hardware block to perform the following steps:

i. writing into memory block 14 values n, gᵢ, xᵢ

ii. ordering sequencer 11 to execute the reduction algorithm

iii. reading the result in memory block 14

Values n and gᵢ are independent of the value x to be reduced, modulo n, so that it is not necessary to rewrite these values into the memory before each new modular reduction.

Values tₙ and n′ are used by multiplier block 12. Adder block 13 only uses value tₙ.

As an example, during the first step (i.), the values recorded in memory 14 can be placed at the following addresses:

n occupies the machine-words with addresses 0 to tₙ,

g₀ occupies the machine-words with addresses tₙ+1 to 2 tₙ,

g₁ occupies the machine-words with addresses 2 tₙ+1 to 3 tₙ, . . .

gₖ₋₁ occupies the machine-words with addresses k.tₙ+1 to (k+1).tₙ

x occupies the machine-words with addresses (k+1).tₙ+1 to 2 k.tₙ.

u occupies the machine-words with addresses (2k)tₙ+1 to (2k+1)tₙ

s occupies the machine-words with addresses (2k+1)tₙ+1 to (2k+2)tₙ

The temporary variables u and s initialised at zero and a location is reserved for recording the result at addresses (2k+2)tₙ+1 to (2k+3)tₙ.

Three parameters are passed on to multiplier block 12 on each call. The first parameter is the address in memory 14 of the first operand, the second parameter is the address in memory 14 of the second operand and the third parameter is the address in memory 14 of the location in which it is intended to record the results of the multiplication.

Two parameters are fed to adder block 13, the two parameters corresponding to the addresses of the two operands in memory 14. The result of the addition is placed at the address of the second operand.

Sequencer 11 can then run the modular reduction process with the data in memory as follows:

MMul((k+1)tₙ+1, tₙ+1,(2k)tₙ+1) (addresses of x₀, g₀ and u)

MAdd((2k)tₙ+1,(2k+1)tₙ+1) (addresses of u and s)

MMul((2k−1)tₙ+1, tₙ+1,(2k)tₙ+1) (addresses of xₖ, g₀ and u)

MAdd ((2k)tₙ+1,(2k+1)tₙ+1) (addresses of u and s)

MMul((2k+1)tₙ+1, address(1), (2k+3)tₙ+1)) (the second parameter is set to a value 1).

The input parameters of multiplier block 12 are addresses in memory so that calculation MMul(s,1) can be accomplished either by setting value 1 to a specific address in memory 14 or by the special sequencing of the block in which the second parameter is set to a value 1.

The Montgomery process used by multiplier block 12 produces a result included between 0 and 2n−1, congruous with the modulo n conventional result. The operation MMul(s, 1) gives de conventional result.

Multiplier block 12 manipulating the modulo 2n data, adder block 13 therefore has to carry out modulo 2n additions. It carries out these additions using a multiprecision adder, a multiprecision subtractor and a multiprecision comparator. Accordingly, modular addition operation a+b mod 2n of two numbers a and b is carried out as follows:

calculate t=a+b

if t>=2n, calculate t=t−2n

return t

where t is a variable containing the addition result.

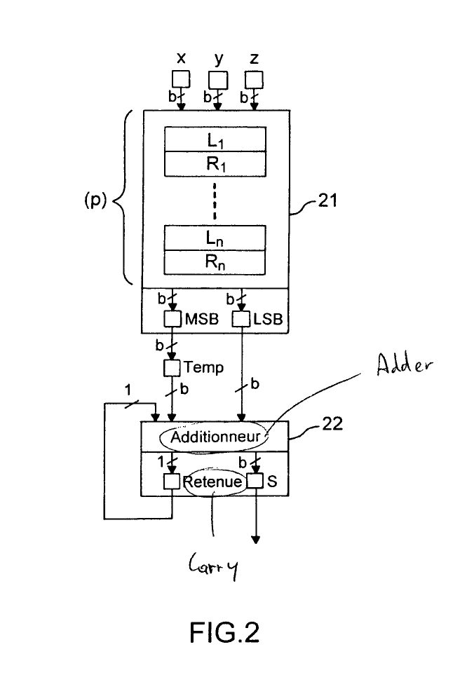

FIG. 2 is an example of a multiplication-addition cell used by multiplier block 12 to perform the operation S←pᵢ.q+(mᵢn+S)/r of the process described above. The cell is pipelined to improve its performance. The pipeline consists in adding registered barriers between the logic phases to reduce the critical path and in this way increase the maximum operating frequency (in theory that of an adder in r).

The depth of the pipeline of an elementary component is defined by its number of internal registers. We do not count the output register.

The example given in FIG. 2 presupposes that we have a pipelined multiplier-adder 1 having a depth p.

In particular it includes a set of logic-register couples (Ii, ri). Number p of these couples is chosen in particular so that the maximum frequency F1max of the pipelined multiplier-adder is greater than or equal to the maximum frequency F2max of the adder and the values of these two frequencies are as close together as possible.

The maximum operating frequency of the multiplier-adder is given by the inverse of the performance time of the multiplication-addition operation whereas the maximum operating frequency of the pipelined multiplier-adder is given by the inverse of the performance time of just one of the p stages. For optimal operation, we determine the maximum frequency of the adder which gives de adder performance time and subdivide the multiplier-adder into p crossing time stages that are less than or equal to that as close as possible to the performance time of the adder.

The inputs of multiplier-adder 21 correspond to three digits: pᵢ, qⱼ and vⱼ and the output is a pair of digits corresponding to LSB(pᵢqⱼ+vⱼ) and MSB(pᵢqⱼ+vⱼ). The output is contained within two digits.

The results of the multiplier-adder transmitted to a three-input adder bearing reference 22: digit+digit+carry→digit+carry, operating in 1 cycle (pipeline 0) at a frequency F2max.

The Temp register corresponds to the storage of c required for the following calculation: addition of c with the following LSB and the previous carryover.

The data (digits p×Q+V) are therefore output in series on each cycle with the LSB leading, in the same direction as the propagation of the carryover.

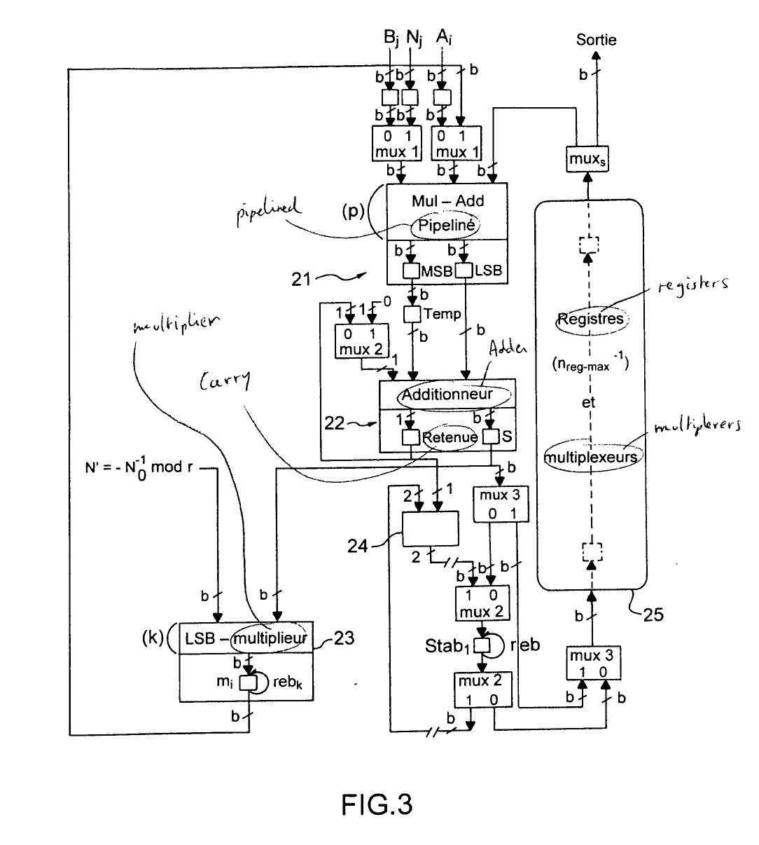

FIG. 3 describes an example of multiplier block 12, with a device 3 adapted to the low part of the multiplication, and a device 5 comprising registers and multiplexers.

In this example, the main components of the circuit are: a pipelined multiplier-adder 21, an adder with 3 inputs referenced 22, a low part multiplier 23 and a 2 bits+1 bit to 2 bit adder, designated as 24, a barrier n_{reg-max}−1 of registers and multiplexers designated 25.

The number of multiplexers and registers depends more particularly on the intrinsic data of the circuit, the depths of pipeline p and k, and the number of data digits.

In the example of FIG. 3, the barrier of n_{reg-max}−1 registers and multiplexers (component reference 25) is designed especially to delay the input of data to multiplier-adder 1.

### Low Part—Component 3 Multiplication

In the main loop of the algorithm, on each bit oration we determine mᵢ, the digit rendering the quantity S+mᵢN divisible by r. mᵢ is determined by the partial multiplication of the LSB of S with a constant N′, precalculated once and for all for a given modulus N. In this multiplication, only the lower part concerns us: we perform this modulo r operation.

This operation is slower than an addition and is also pipelined. We call the depth of the pipeline of this operator k and presuppose that k<p.

### Looping, Latency and Additional Registers

get a distinction is made between the two cases, a change from a conventional multiplication aᵢB+T→S, (1), to multiplication and shifting (mᵢ×N+S)/r→T, (2), and a change from (2) to (1), in which the delay is not the same.

This delay determines in particular the number of registers to be used: n′_{reg} or n_{regk} according to the case. Thus for instance, in the change from (2) to (1), and in a case where p+2≦n (case where n′_{reg} is defined), the number of registers to be used is n′_{reg}. Since we have n_{reg-max}−1, we have to jump n_{reg-max}−1−n′_{reg}. This is done by means of multiplexers arranged accordingly.

Change from (1) to (2)

To be able to chain the multiplication-additions (1) and (2) without any loss of time (that is without adding any latency), we need to determine m before having covered all the digits of the multiplication under way. Therefore it is desirable to obtain the condition: p+k+2≦n.

Indeed, the LSB of the multiplication-addition results is available when index digit p+1 appears at the input of the multiplier-adder.

Addition is carried out during the following cycle. S₀ is available and the calculation of mᵢ can therefore begin.

After k+1 additional clock strokes mᵢ is available at the output of the low part multiplier. It can therefore be used as an input to the multiplier-adder on the next clock stroke. This explains the condition p+k+2≦n.

### Looping

If we want to chain together multiplications-additions (1) and (2), without losing any time we choose p+k+2≦n.

In this case, data mᵢ is available before the end of the run-through of the current multiplication-addition digits. We loop this value in order to delay its input into the multiplier-adder. We then define n_{rebk}=n-p-k-2 corresponding to the number of loops of this value needed.

In the particular case where n_{rebk}=0, data mᵢ is synchronous with the new inputs of the multiplier-adder.

But in every case, we loop the value of mᵢ n times so that the input is the same for all the digits of N.

If, conversely, n-p-k-2 is negative, if corresponds to a delay in calculating mᵢ, so we have to add the latency.

### Latency

When condition p+k+2≦n is not obtained, it means that the outputs are delayed with respect to the inputs, and waiting times (latency) are added to synchronise the data.

During these latency times, the inputs are stopped (in that when we use as a new input 0 (to allow for the last retention of S)), calculation continues for the data already input.

In this case (p+k+2>n), we define nₗₐₜₖ=p+k+2−n. This magnitude represents the number of latency strokes to be applied before new data are presented to the multiplier-adder.

As soon as mᵢ has been determined, it is used as input for multiplication-addition. As far as S₀ is concerned, it has to be determined before mᵢ and must be stored (together with S₁, S₂ . . . ) until mᵢ has been calculated.

That is why we add registers to delay the arrival of the results at the input of the multiplier-adder.

### Additional Registers

There are two possible cases. Depending on whether p+k+2 is greater than or smaller than n, the number and use of the added registers are however not the same.

Case 1: p+k+2≦n

In this case, group S₀ and mᵢ is determined before the end of the data digit run-through.

For mᵢ, see the section on looping; we use the method described above in the looping section.

For S₀, we delay its arrival at the input of the multiplier-and thereby adding shift registers.

We then define n_{reg} by n_{reg}=n−p−1. This quantity corresponds to the number of registers to be added to synchronise the input of the LSB of the multiplication-an additional result with the least significant data of the next one.

Case 2: p+k+2>n

They are two sub-cases depending on whether p is or is not greater than n. In fact, whatever the value of p, mᵢ will be determined after S₀.

Therefore we delay the arrival of S₀ at the input of the multiplier by adding registers. This number of registers will therefore depend only on k, the depth of the lower part multiplication operator pipeline.

In this case we therefore define n_{regk}=k+1 the number of registers to be added to delay the arrival of S₀ at the input of the multiplier.

Change from (2) to (1)

Here, we take a look at the change from (2) to (1). If there is no m to be determined, on the other hand, will have to allow for the shifting (division by r).

In the same way as previously, the input of the results is synchronised with the input of the new data. Here, only quantity p is important and there is no need to determine mᵢ and k is not involved.

Conversely, we allow for the offset (i.e.: we consider t₀ to be an LSB rather than t₋₁ which is zero). This can be seen as an additional pipeline level.

### Additional Registers and Latency

A distinction is made in the same way as previously between two cases, depending on whether p+2 is>n or not.

Case 1: p+2≦n

In this case, t₀ is available before the end of the run-through of the data digits. Therefore we add registers to allow for the delay. We then define n′_{reg}=n−p−2 indicating the number of registers to be added to allow for the delay.

Case 2: p+2>n

In this case, to is available after the run-through of the data digits. Therefore, we delay the input of new data. This is done as before by adding waiting strokes (latency). We define n′ₗₐₜ=p+2−n which represents the number of waiting strokes to be applied.

### Supplementary Adder and Looping

The determination of tₙ is obtained by the addition of Sₙ₊₁ with c, Sₙ₊₁≦2 and c≦1. To do this, we include an adder (logic) for 2 bits+1 bit to 2 bits (tₙ≦3) (designated component 24).

In the calculation of T, the shift is a way of saving on the use of a register. It is used for storing Sₙ₊₁. This value is stored until c has been determined, then the addition of the two is carried out to release the storage register Sₙ₊₁.

Therefore we define n_{reb}=n+nₗₐₜₖ−1 which is the number of loops necessary for Sₙ₊₁.

### Correction Parameters

The final design of the component depends in particular on the depths of the pipeline p and k and on the number of digits n in the long integers for which it is initially designed. In particular, the number of registers to be added is a tricky point because it is not the same in the changeover from (1) to (2) as it is in the changeover from (2) to (1).

The following synthesis table 1 links together the quantities p, k and n with the previously defined correction parameters.

TABLE 1

| | |
|---|---|
| p + k + 2 ≦ n | p + k + 2 > n |

| | [symbol] p + 2 ≦ n) | p + 2 ≦ n | p + 2 > n |
|---|---|---|---|
| n′_{reg} | n − p − 2 | n − p − 2 | 0 |
| n′ₗₐₜ | 0 | 0 | p + 2 − n |

| | | |
|---|---|---|
| n_{reg} | n − p − 1 | k + 1 |
| nₗₐₜₖ | 0 | p + k + 2 − n |
| n_{rebk} | n − p − k − 2 | 0 |
| n_{reb} | n + nₗₐₜₖ − 1 = n − 1 | n + nₗₐₜₖ − 1 = p + k + 1 |

In theory, the number of registers to be added is defined by n_{reg-max}=max(n_{regk},n_{reg}) and equals n−p−1 if p+k+2≦n and k+1 otherwise. In particular, n_{reg-max}≧1.
The steps requiring fewer registers are carried out by shortening the string of registers and by adding multiplexers.

### Sequencing Described in FIG. 3

An example of the sequencing of operations is described in relation to FIG. 3. We adopt the convention of defining the states of the multiplexers at the end of the current clock stroke to control the following clock stroke.

### General Multiplexer Behaviour

This involves latency. Depending on whether there is latency or not, the changes of state do not take place at the same times.

However, it is possible to use circuit latency correction parameters (n′ₗₐₜ and nₗₐₜₖ) to define the general behaviour of the multiplexers.

Indeed, it can be assumed that |B|=n+1+n′ₗₐₜ with the n′ₗₐₜ first digits of B being nil. (Except obviously for the calculation of a₀B).

Similarly, it can be assumed that |N|=n+1+nₗₐₜₖ with the nₗₐₜₖ first digits of N being nil.

In addition, we isolate the case of the first calculation of a₀B for which we do not take into consideration the latency (the n′ₗₐₜ first nil digits of B).

Then, after going through this particular case, we see that the data presented successively at the input of the multiplier-adder can be grouped in sets of 2n+2+n′ₗₐₜ+nₗₐₜₖ data. The nₗₐₜₖ+n+1 first correspond to the data m and Nⱼ. The n′ₗₐₜ+n+1 last correspond to data aᵢ and bⱼ.

This will entail cyclic operation of the multiplexers with a period 2n+2+n′ₗₐₜ+nₗₐₜₖ
mux1
mux1 is a two state multiplexer symbolising the type of input to be taken into consideration by the multiplier-adder. The two states are:

0: x=aᵢ and y=bⱼ are considered as inputs of the multiplier-adder.

1: x=mᵢ and y=Nⱼ are considered as inputs of the multiplier-adder.

The use of constants n′ₗₐₜ and nₗₐₜₖ in particular allow a check to ensure that the change of state occurs when all the digits of B (or of N) have been run through.

For a₀ we do not take into consideration the n′ₗₐₜ first nil digits. Calculation begins directly with the data a₀b_{n′lat}.

Thus mux1, initially set to 0 (reset), remains in this state for the first n strokes of the clock then goes to state 1 on the n+1^{st} stroke.

At the end of this n+1st/cover the data presented at the input of the multiplier-adder is set to a₀ and bₙ, and all the digits of B will have been run through.

mux1 is at 1 at the end of this clock stroke and therefore at the end of the following clock stroke, m₁ and N₀ will be presented at the input of the multiplier-adder.

The general behaviour of mux1 depending on the clock stroke can be summarised by the following steps:

If clock<n+1, then mux1=0

If not:

If (clock−(n+1)mod(2n+2+nₗₐₜₖ+n′ₗₐₜ))<n+1+nₗₐₜₖ, then mux1=1

If not mux1=0

mux2

mux2 is a two state multiplexer symbolising the time at which the addition sₙ₊₂+c has to be performed. Note that Sₙ₊₂ is stored in Stab₁.

In addition, when this addition is made, the carryover of the three-input and there must be initialised that 0 because a new addition is beginning.

The two states are:

0: addition sₙ₊₁+c cannot take place, c has not yet been determined.

1: Inputs Sₙ₊₁ and c are set in such a way as to be added on the next clock stroke and the carry forward of the three state adder is initialised at 0.

This addition is carried out once by the main iteration (loop on i), and is situated in the second loop of the digits for N.
This means that mux2 is never in state 1 twice in a row.
What is more, this addition concerns the values of the Stab1 register and therefore the depth of pipeline p which is involved in determining the behaviour of mux2.

The LSB digit (s₀) of product a₀×b₀ is in the output register of the adder at clock p+3 (=1(load)+(p+1)(so in LSB)+1(s₀ in the output register of the adder)).

sₙ is therefore in this same register at clock p+3+n. Since sₙ corresponds to the LSB of a₀×bₙ, the following inputs are therefore digits for N and m₁.
But the addition must be carried out when tₙ₋₁ is in the adder register output because at that time, we have the right carry value to be added to sₙ₊₁ to determine tₙ.
mux2 must therefore be in state 1 when tₙ₋₁ is in the adder output register that is on clock stroke p+3+n+nₗₐₜₖ+n+1=p+2n+nₗₐₜₖ+4. (Remember that with the shift tₙ₋₁ corresponds to the calculation of m₁×Nₙ).
By periodicity, we can also describe the general behaviour of mux2.

If clock=p+2n+4+nₗₐₜₖ mod 2n+2+nₗₐₜₖ+n′ₗₐₜ, then mux2=1

If not mux2=0

mux3

During a loop for the digits of N, a shift to the right must be made on the output digits to allow for division by r.

mux3 is a two state multiplexer symbolising exactly when the shift is made (modified by a registered shift). The two states are:

0: the shift is not made.

1: the shift is made.

This index shift is carried out by hardware by jumping a register.

The shift occurs when the data sₙ₊₁ appears in the Stab1 register. At that time, register S of the adder contains, depending on the value of nₗₐₜₖ, either 0 (results of a latency stroke) or the value of t₀. t₀ having a delay time with respect to the conventional multiplication (s₀), it must jump a register in order to catch up on this delay time. This shift must therefore be made until all the digits in (including latency) of T, up to tₙ₋₁, have been determined. Indeed, when tₙ₋₁ has been determined (i.e.: in register S of the adder) on the next clock stroke, tₙ is determined in Stab1 by the addition of c with sₙ₊₁, and tₙ₋₁ is to be found in the Stab2 register. The shift and then ends and the data of tₙ₋₁ and tₙ are again to be found in the two successive registers. mux3 therefore remains in state 1 for n+nₗₐₜₖ=n_{reb}+1 strokes.

As mentioned previously, the shift corresponds to the jumping of the Stab1 register which is then used for looping ssₙ₊₁. The looping of sₙ₊₁ thus occurs at the same time as the shift. Therefore the change of state of mux3 from 0 to 1 also indicates that it is necessary to loop the value of sₙ₊₁ in the Stab1 register. This looping takes place n_{reb} times.

Initially, mux3 is in state 0 (conventional multiplication). It changes to 1 when sₙ₊₁ is in the Stab1 register. But sₙ is in S on clock stroke p+3+n (cf: behaviour of mux2). Therefore sₙ₊₁ is in the same register on stroke p+n+4, and in Stab1 on the next stroke: p+n+5.

By periodicity, we work out the general behaviour of mux3:
If clock<p+n+5, then mux3=0

### If not:

If (clock−(p+n+5)mod(2n+2+nₗₐₜₖ+n′ₗₐₜ))<n_{reb}+1, then mux3=1

If not mux3=0

The previous remark makes it possible to define and describe the reb control.

### Reb Control

This control represents the moments for which sₙ₊₁ has to be looped in the Stab1 register.

The two states are:

0: no looping

1: looping

The behaviour of reb is described at the same time as that of mux3. We can therefore deduce that:

If clock<p+n+5, then reb=0

### If not:

If (clock−(p+n+5)mod(2n+2+nₗₐₜₖ+n′ₗₐₜₖ))<n_{reb}, then reb=1

If not reb=0

mux4

mux4 is a two-state multiplexer which is part of the new register barrier.

If this multiplexer is present, it indicates whether it is necessary to use n′_{reg} or n_{regk} registers. The two states are:

0: Use of all the registers (corresponding to multiplication (2)).

1: Use of n′_{reg} registers (corresponding to multiplication (1)).

mux4 must be in state 1 when t₀ is determined in S. We have seen (cf:mux3) that sₙ₊₁ is present in S at clock=p+n+4, thus nₗₐₜₖ+1 o'clock strokes later that is at clock=p+n+5+nₗₐₜₖ, to is in S.

mux4 must remain at 1 until tₙ is in Stab1 i.e. for n+1 clock stroke

By periodicity, we can deduce the general operation of mux4:

If clock<p+n+5+nₗₐₜₖ, then mux4=0

### If not:

If (clock−(p+n+5+nₗₐₜₖ)mod(2n+2+nₗₐₜₖ+n′ₗₐₜ))<n+1, then mux4=1

If not mux4=0

rebₖ Control

Control rebₖ indicates at what moment it is necessary to loop the value of mᵢ in the lowpass multiplier output register.

The two states are:

0: no looping

1: looping

Initially, rebₖ=0.
m₁ is determined (i.e.: present in the output register of the low part multiplier) at the end of the clock stroke, clock=p+k+4. Indeed, m₁ is determined from so which is itself present in register S at the end of clock stroke clock=p+3 (cf:mux2). Therefore it can be used as an input for the low part of the multiplier which gives the result k+1 clock strokes later, or at clock=p+k+4.
Thus, we have to loop this value starting from this moment at a least n+1 times so that this input is the same for all the digits of N. it is also necessary to allow for the value of n_{rebk} which is the number of looping operations needed for m₁ in the case where m₁ is determined before the run-through of all the digits of B.
The total looping number of m₁ and is therefore: n+1+n_{rebk}.
By periodicity, we deduce the general behaviour of rebₖ:
If clock<p+n+4, then rebₖ=0

### If not:

If (clock−(p+n+4)mod(2n+2+nₗₐₜₖ+n′ₗₐₜ))<n+1+n_{rebk}, then rebₖ=1

If not rebₖ=0

According to one embodiment, modular reduction device 1 is coupled with other calculation operators such as, for instance, a modular exponentiation device. It can also share within the same hardware block the basic functions of addition 12 modular multiplication 12 and memory block 14. The value of x to be reduced can then be the result of operations performed by other hardware block operators and the result of the modular reduction can be used as an input for other operators.

The architecture of the multiplier and adder blocks and the modular reduction process carried out by the sequence and makes it possible to work on numbers of any size. Bearing in mind that the sizes of the encryption keys used by the cryptographic systems increase regularly over the years, the device according to the invention offers the advantage of being able to process very large numbers.

The modular reduction device benefits from very good performance and flexibility of the multiplier used.

Another advantage of the modular reduction device according to the invention is that it proposes a solution that can be easily integrated into a cryptographic component proposing other calculation functions.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A modular reduction device comprising a multiplier using a Montgomery multiplication operation using a high numeration base r, equal to or greater than 4.

2. The modular reduction device according to claim 1, wherein multiplier uses the following algorithm:
i. S←p₀.q
ii. For i ranging from 0 to tₙ−1, use:
a. mᵢ←S₀.n′ mod r
b. S←pᵢ.q+(mᵢn+S)/r
iii. mₜₙ←S₀.n′ mod r
iv. S←(mₜₙ.n+S)/r
Where tₙ designates the size of module n in a number of machine-words, p and q the operands to be multiplied, mᵢ the intermediate coefficients, S the result of multiplication and where value n′ equals −n⁻¹ mod r.

3. The modular reduction device according to claim 1, comprising a multiplier-adder consisting of p pipelined logic-register couples, receiving several digits to be added and to be multiplied, at least two outputs corresponding to the LSB and MSB, an adder receiving the two outputs of the multiplier-adder, with number p chosen so that the maximum frequency F1max of the multiplier-adder is higher than or equal to the maximum frequency F2max of the adder.

4. The modular reduction device according to claim 1, comprising a sequencer, an adder block and a memory module, with one output of the sequencer connected to the input of the multiplier control, one output of the sequencer being connected to an adder block control input and one output of the sequencer being connected to one control input of the adder block and the memory module being connected to the multiplier and the adder for data exchange.

5. A cryptographic component including a modular reduction device according to claim 1.

6. The modular reduction device according to claim 2, comprising a multiplier-adder consisting of p pipelined logic-register couples, receiving several digits to be added and to be multiplied, at least two outputs corresponding to the LSB and MSB, and adder receiving the two outputs of the multiplier-adder, with number p chosen so that the maximum frequency F1max of the multiplier-adder is higher than or equal to the maximum frequency F2max of the adder.
